(19) United States
(12) Patent Application Publication
(10) Pub. No.: US 2023/0339129 A1
(43) Pub. Date: Oct. 26, 2023

(54) Hair Grooming Device

(71) Applicant: Kendall Harris, Burton, MI (US)

(72) Inventor: Kendall Harris, Burton, MI (US)

(21) Appl. No.: 18/138,648

(22) Filed: Apr. 24, 2023

Related U.S. Application Data
(60) Provisional application No. 63/335,049, filed on Apr. 26, 2022.
(60) Provisional application No. 63/341,105, filed on May 12, 2022.

(51) Int. Cl. B26B 19/38; B26B 19/06

(52) U.S. Cl. CPC B26B 19/3846; B26B 19/06; B26B 19/386; B26B 19/388

(57) ABSTRACT

A handheld grooming device in which a user can pivotally adjust the trimming region to improve the ease of use when trimming hair to achieve a curved style or to trim along a curved body surface from which the hair is being cut.

### CROSS-REFERENCE TO RELATED APPLICATION

This application claims the benefit of U.S. Application No. 63/335,049 filed on Apr. 26, 2022; and U.S. Application No. 63/341,105 filed on May 12, 2022, the contents of each which are incorporated herein by reference.

### TECHNICAL FIELD

The present invention relates generally to a device for hair grooming, and more particularly to a hair trimmer with a curved blade.

### BACKGROUND

Hair grooming is important to many people wishing to express or present themselves in a certain way. Using standard razors to cut hair can be difficult, even for experienced barbers as side hairlines can be difficult to match. Some hair may be missed or hard to reach, and un-identical hair and beard lines can be disappointing for a client and frustrating to fix.

. Additionally, conventional handheld hair grooming devices are configured with blade assemblies that are fixed a single orientation in relation to the body of the grooming devices during grooming operations. This requires a user of the grooming device to manipulate the orientation of the grooming device as a whole in order to properly position the blade assembly to trim along a desired path. Using a grooming device in this way introduces a risk of error or requires additional time in order to achieve the desired trim consistently. These problems are significant where users seek to style a curved trim on either themselves or others.

Thus, it would be desirable to provide a handheld grooming device that provides users with a handheld curved razor that can provide a precision cutting function, particularly for cutting temple hairlines and beards.

It is also desirable to provide a device that enables users to lock the blade in place, flipping from one side to the other to make an identical razor line.

It is desirable to provide a device that offers a away for personal use, use by barbers, stylists, etc. to easily cut identical hairlines on sideburns, beards etc. in a manner that may shorten haircut time and/or to fit an stylistic curve or to create it.

### SUMMARY

Disclosed herein is a handheld grooming device where a user can pivotally adjust the trimming region to improve the ease of use when trimming hair to achieve a curved style or to trim along a curved body surface from which the hair is being cut.

In one embodiment disclosed, a user may change the orientation of a curved blade that is releasably attached to the handle of the hair trimmer in order to style hair quickly and consistently in a curved shape. Changing the orientation of the curved avoids the need to attach a different blade and the need to greatly manipulate the handle of the hair trimmer. Thus, a user saves time and achieves a consistent style with each trim.

In another embodiment, the device includes a trimmer head, a trimmer body, and an attachment mechanism. The trimmer head includes at least one blade member, wherein the at least one blade member has a planar body having at least one curved edge region and one or more cutting edges located on the at least one curved edge region. The at least one curved edge region may be coplanar to the planar body of the at least one blade member. The trimmer body includes a shaft defining a longitudinal axis and a longitudinal plane. The shaft includes a first end and second end opposed to the first end. The attachment mechanism may be positioned at the first end of the shaft, wherein the trimmer head is releasably connected to the attachment mechanism. Once connected to the attachment mechanism, the trimmer head may be pivotal between at least one first fixed use position and at least one second fixed use position on pivot plane. Both the at least one first fixed use position and the at least one second fixed use position are defined by an orientation angle. The orientation angle is defined by a degree between a center axis and the longitudinal axis.

Additional embodiments and details of the above embodiments are described in further detail below.

### BRIEF DESCRIPTION OF THE DRAWINGS

The foregoing features of the disclosed embodiments will become more fully apparent from the following description and affixed claims, in conjunction with the accompanying drawings. The drawings are only typical embodiments and are not to be construed as limiting of its scope. In the drawings:

FIG. 1 is an elevation view of one embodiment of a hair grooming device;

FIG. 2 is an elevation perspective view of the embodiment shown in FIG. 1;

FIG. 3 is a plan perspective view of the embodiment shown in FIG. 1;

FIG. 4A is an elevation view of the embodiment shown in FIG. 1;

FIG. 4B is an elevation view of the embodiment shown in FIG. 4A in a first fixed use position;

FIG. 4C is an elevation perspective view of the embodiment shown in FIG. 4B in a second fixed use position;

FIG. 4D is an elevation perspective view of the embodiment shown in FIG. 4B in a second fixed use position;

FIG. 5A is an elevation perspective view of the embodiment shown in FIG. 4D being used;

FIG. 5B is an elevation perspective view of a final result of the embodiment used in FIG. 5A;

FIG. 6A is an elevation view of one embodiment of a hair grooming device;

FIG. 6B is an elevation view of another embodiment shown in FIG. 6A;

FIG. 7A is an elevation view of the embodiment device shown in FIG. 6A;

FIG. 7B is an elevation view of the embodiment shown in FIG. 6A with the trimmer head in a second fixed use position;

FIG. 7C is an elevation view of the embodiment shown in FIG. 6A with the trimmer head in a second fixed use position;

FIG. 7D is an elevation view of the embodiment shown in FIG. 6B with the trimmer head in a second fixed use position;

FIG. 8A is an elevation isometric view of the embodiment shown in FIG. 6 with the trimmer head in a storage position lateral to the trimmer body;

FIG. 8B is an elevation view of the embodiment shown in FIG. 6 with the trimmer head in a storage position lateral to the trimmer body;

FIG. 9 is a block diagram of the components that may be included in one embodiment of a hair grooming device.

FIG. 10 is a plan perspective view the embodiment shown in FIG. 1;

FIG. 11A and B are elevation isometric views of a stationary blade and reciprocating blade of the embodiment of the grooming device as disclosed herein;

FIG. 12A-C are side views of a third embodiment of the grooming device as disclosed herein; and

FIG. 13 is an illustration of the grooming device of FIG. 12A-C depicting the blade in a plurality of indexed positions.

### DETAILED DESCRIPTION

In the following specification and the claims, reference will be made to a number of terms, which shall be defined to have the following meanings. The singular forms “a,” “an,” and “the” include plural references unless the context clearly dictates otherwise. The terms “comprising,” “including,” and “having” are intended to be inclusive and mean that there may be additional elements other than the listed elements. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The present disclosure is directed to a hair grooming device that can be used to quickly achieve a consistent trim. Quickly achieving a consistent trim can be complicated where the desired trim is curved. This usually involves manipulating the orientation of a hair grooming device as a whole to trim along the desired curved path, which may increase the time the device is used or produce different results with each use. Users using the device on themselves or others both experience these problems.

In another embodiment, the device includes a trimmer head, a trimmer body, and an attachment mechanism. The trimmer head includes at least one blade member, wherein the at least one blade member has a planar body having at least one curved edge region and one or more cutting edges located on the at least one curved edge region. The at least one curved edge region may be coplanar to the planar body of the at least one blade member. The trimmer body includes a shaft defining a longitudinal axis and a longitudinal plane. The shaft includes a first end and second end opposed to the first end. The attachment mechanism may be positioned at the first end of the shaft, wherein the trimmer head may be releasably connected to the attachment mechanism. Once connected to the attachment mechanism, the trimmer head may be pivotal between at least one first fixed use position and at least one second fixed use position on pivot plane. Both the at least one first fixed use position and the at least one second fixed use position are defined by an orientation angle. The orientation angle may be defined by a degree between a center axis and the longitudinal axis.

In certain embodiments. the grooming device as disclosed herein can include at least one double-sided razor having a curved blade surface. The double-sided curved configuration can permit the user to line hair and beards in order to make an accurate hair cut that is and essentially identical symmetrical cut on both sides of the face in an manner that glides through hair without causing injury or damage to the skin .

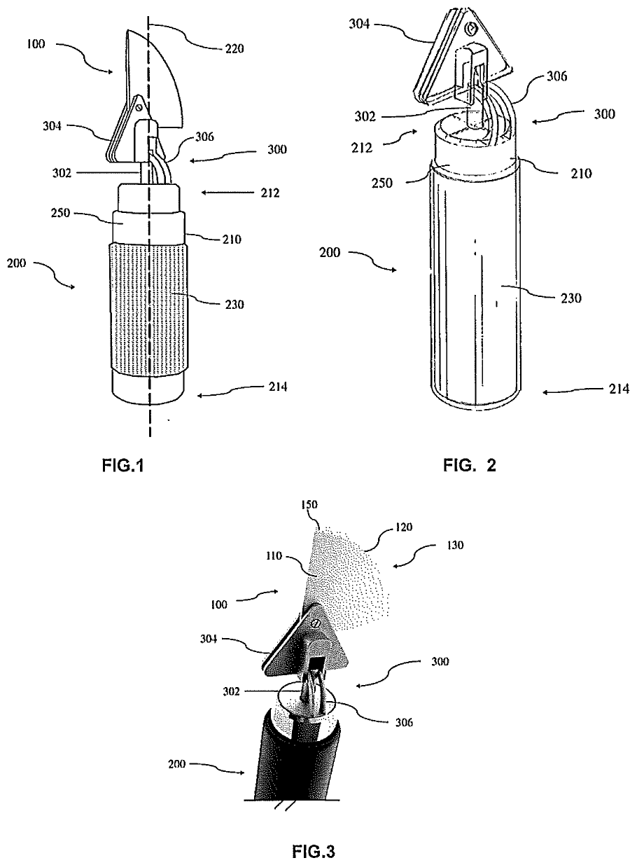

Turning now to FIGS. 1-3, one embodiment of the device may include a trimmer head 100, a trimmer body 200, and an attachment mechanism 300. The trimmer body 200 and the attachment mechanism 300 may be comprised of suitable materials such as metals, ceramics, plastics, or silicones, or the like or a combination or sub-combination thereof. Other materials such as wood may also be used for the trimmer body 200 and the attachment mechanism (e.g., decorative wood accents).

The trimmer body 200 may include a shaft 210 that generally defines a longitudinal axis 220 and a first longitudinal plane (not shown). The shaft 210 may have a first end 212 and a second end 214 opposed to the first end 212. In certain embodiments, the longitudinal axis 220 may be positioned to extend through the center of the trimmer body 200 (e.g., the longitudinal axis 220 may extend through the center of the first end 212 and the second end 214, or the like). The shaft 210 may be shaped to be held ergonomically (e.g., sized to fit a user's hand, shaped to be held and wielded comfortably, or a suitable combination thereof). Optionally, the shaft 210 may include a grip 230 disposed on the outer body surface of the shaft 250. The grip 230 may be composed of a suitable material such as silicone, plastic, ceramic, wood, or the like or a combination or sub-combination thereof. In other non-limiting embodiments, the shaft 210 or the grip 230, may include indentations or depressions to facilitate comfortable operation of the device while it may be being held by a user (not shown). Optionally, the grip 230 may be texturized.

The attachment mechanism 300 may be positioned at the first end 212 of the shaft 210. The trimmer head 100 may be releasably connected to the attachment mechanism 300. For example, the trimmer head 100 may be detachable from the attachment mechanism. Accordingly, the trimmer head 100 may be removed and a different trimmer head 100 embodiment may be connected to the attachment mechanism 300. However, in other embodiments the trimmer head 100 may be affixed to the attachment mechanism 300 without departing from the scope of the present invention. Optionally, the attachment mechanism 300 may be configured to swivel while the trimmer body 200 remains stationary.

The attachment mechanism 300 may include a receiving member 302 distal to the shaft 210 and a blade mount 304 proximate to the trimmer head 100. The blade mount 304 may be configured to releasably connect to the trimmer head 100 and may assist in securing the blade member 110. In certain embodiments, the trimmer head 100 may include the blade mount 304, rather than the attachment mechanism 300. The blade member 110 may be releasably connected to the blade mount 304, providing a means to interchange different blade members 110 to the trimmer head 100.

In other embodiments, the receiving member 302 may be configured to receive the trimmer head 100 or the blade mount 304 (e.g., the trimmer head 100 or blade mount 304 may be releasably connected to the receiving member 302 or slot into the receiving member 302 with matching part such as a male-female connection, or the like, or a combination or sub-combination thereof). The receiving member 302 may include structures necessary to mechanically engage and/or secure the trimmer head 100 to the attachment mechanism 300, mechanically pivot the trimmer head 100, or the like or a combination or sub-combination thereof. The receiving member 302 may also include structures or components necessary to facilitate electrical communication between the attachment mechanism 300 and the trimmer head 100. In further embodiments, the receiving member 302 may include a securing mechanism 306. The securing mechanism 306 may provide structural support or aid in mechanically engaging and/or securing the trimmer head 100 to the receiving member 302, pivoting the trimmer head 100, or the like or a combination or sub-combination thereof.

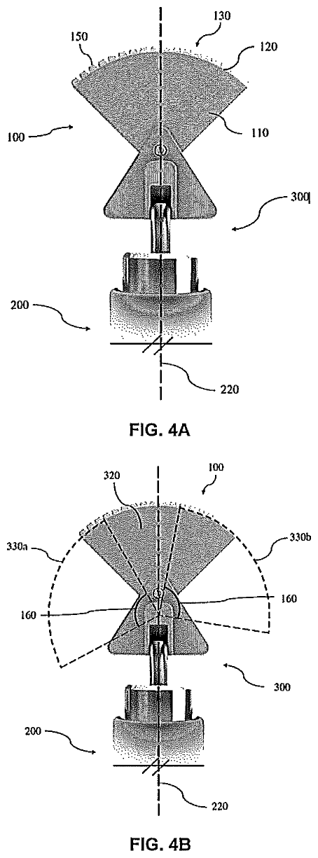

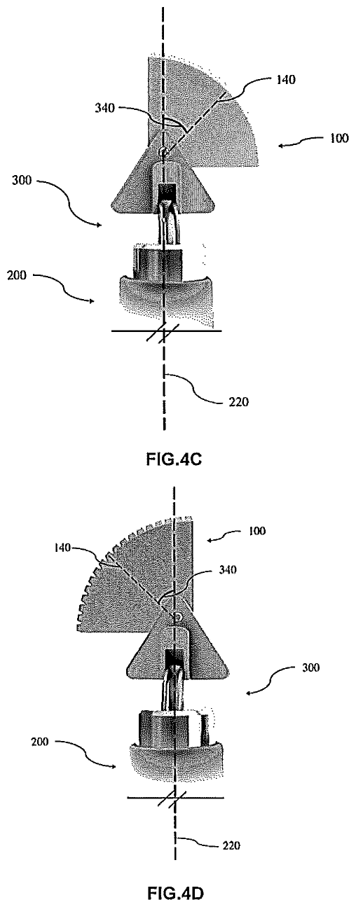

Referring to FIG. 4A, one embodiment of the trimmer head 100 may be comprised of at least one blade member 110 having a substantially planar body (e.g., the body of the blade member is mostly within a single plane of suitable thickness). The blade member 110 may include at least one curved edge region 120 (e.g., a portion of the blade member 110 is arched, hooked, convex, concave, or curvilinear, or the like, or a combination or sub-combination thereof). In certain non-limiting embodiments, the curved edge region 120 may be defined by a suitable arc angle 160. For example, the arc angle 160 may be between 45 degrees and 180 degrees, or the like or a combination or sub-combination thereof. In other embodiments, the arc angle 160 may be between 30 degrees and 210 degrees or between 60 degrees and 120 degrees, or the like or a combination or sub-combination thereof. In further embodiments, the arc angle 160 may be 90 degrees, or the like or a combination or sub-combination thereof.

The blade member 110 may also have one or more cutting edges 130 located on a curved edge region 120. The one or more cutting edges 130 may include two or more teeth 150. The cutting edge 130 may be substantially coplanar to the planar body of the trimmer head 100 such that cutting or trimming of hair is done substantially within the same plane (e.g., the cutting edge 130 has more than a single point of coplanarity with the body of the trimmer head 100). For example, the cutting edge 130 may be curved away from the planar body of the trimmer 100 in certain sections of the cutting edge 130 (e.g., the cutting edge 130 may be curved upward or downward at the sides or between the sides of the cutting edge 130, or the like or a combination or sub-combination thereof). In a similar manner, the teeth 150 may be substantially coplanar to the planar body of the trimmer head 100.

The blade member 110, cutting edge 130, and teeth 150 may be comprised of a suitable material for cutting hair such as metal (e.g., stainless steel, carbon steel, Japanese steel, cobalt steel, and titanium, or the like or a combination or sub-combination thereof). Other suitable materials may include ceramics, plastics, or the like or a combination or sub-combination thereof.

The blade member 110, cutting edge 130, and teeth 150 may be configured to be of suitable size and shape to achieve a desired trim or manner of trimming when using the device. For example, the blade member 110, cutting edge 130, or teeth 150 may be larger or smaller (as compared to certain embodiments) depending on a variety of factors (e.g., the desired trim line, trim location, hair length, hair type, functionality in relation to the attachment mechanism, ergonomics of use, or the like or a combination or sub-combination thereof). In addition, the blade member 110, cutting edge 130, and teeth 150 may be shaped based on the depending on a variety of factors (including those listed previously) such that the shape of the blade member 110, cutting edge 130, or teeth 150 may be circular, rectangular, square, cylindrical, triangular, or the like or a combination or sub-combination thereof.

Optionally, the trimmer body 200 may further include a blade guard (not shown) that may be detachably attached to the blade member 110. The blade guard will protect users from the cutting edge 130 and control the thickness of hair cut by the trimmer body 200. The blade guard may be comprised of suitable materials such as plastics, ceramics, or silicone. The blade guard may cover some or the all of the blade member 110 or the cutting edge 130. The guard may be formed to substantially mirror the shape of the blade member 110 or the cutting edge 130.

Referring to FIGS. 4B-D, the trimmer head 100 may be pivotal between at least one first fixed use position 320 and at least one second fixed use position 330 on a pivot plane orthogonal to the first longitudinal plane. The first fixed use position 320 may be the position of the trimmer head before pivoting to the second fixed use position 330, such that the device may not be limited to the positions shown in FIGS. 4B-D. The first fixed use position 320 and the second fixed use position 330 may be defined by an orientation angle 340. The orientation angle 340 may be defined by a degree between a center axis 140 and the longitudinal axis 220. In certain embodiments, the center axis 140 may be defined by the center axis 140 of the at least one blade member 110. In other embodiments, the center axis 140 may be defined by the center axis 140 of the trimmer head 100. In further embodiments, the center axis 140 may be defined by a connection point between the trimmer head 100 and the attachment mechanism 300, wherein the trimmer head 100 may be releasably connected to the attachment mechanism 300. The connection point may include a base, member, fixture, fastener, or mount, or the like or a combination or sub-combination thereof. In yet further embodiments, the center axis 140 may be defined by an arm 170 extending from the attachment mechanism 300, wherein the trimmer head 100 or blade member 110 are secured to the arm 170. In some embodiments, the arm 170 may be the blade mount 304.

The trimmer head 100 may be pivotal to positions where the degree of the orientation angle 340 may be neutral, positive, or negative and defines a center, right, and left position of the trimmer head 100 respectively. For example, where the degree of the orientation angle 140 is zero, the trimmer head 100 would be in a central or neutral position. Where the degree of the orientation angle 140 is positive the trimmer head 100 would be in a right position (when the device is viewed from the perspective shown in FIGS. 4B-D). Where the degree of the orientation angle 140 is negative the trimmer head 100 would be in a left position (when the device is viewed from the perspective shown in FIGS. 4B-D). The terminology right and left position are to be used for reference and not meant to be limiting.

The trimmer head 100 may be configured to pivot such that the orientation angle 140 may range from between negative 45 degrees to positive 45 degrees. In other embodiments, the orientation angle 140 may range from between negative 90 degrees to positive 90 degrees. In further embodiments, the orientation angle 140 may range from between negative 135 degrees to positive 135 degrees. In further embodiments, the orientation angle 140 may range from between negative 180 degrees to positive 180 degrees.

In certain non-limiting embodiments, the blade member 110, rather than the trimmer head 100, may be pivotal between at least one first fixed use position 320 and at least one second fixed use position 330 on a pivot plane orthogonal to the first longitudinal plane. In some embodiments, the blade member 110 or trimmer head 100 may be pivotal between at least one first fixed use position 320 and at least one second fixed use position 330 on a pivot plane parallel to the first longitudinal plane.

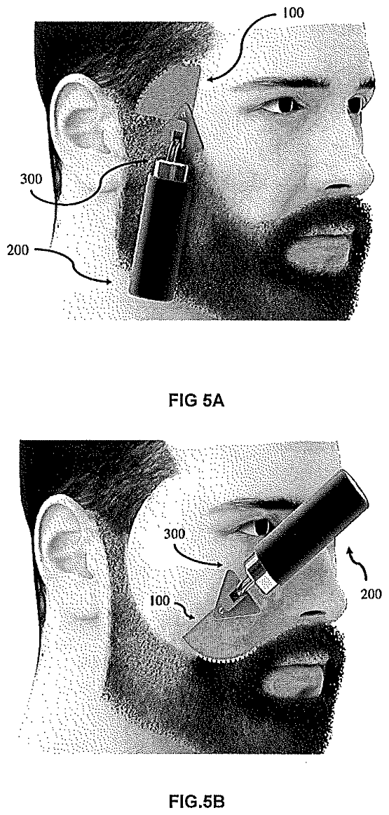

FIGS. 5A and 5B show one embodiment of the device in FIG. 4D being used to trim hair on the side of a user's face. FIG. 5A shows the cutting edge 130 being placed in contact with the hair to cut the hair. The trimmer head 100 is shown with a non-neutral orientation angle 140 and demonstrates how the style of the trim can easily be started by matching up the desired portion of the cutting edge 130 with the hair. The ease with which the trimmer head 100 may be pivoted to match the cutting edge 130 with the desired outline reduces the time to create a consistent style on both sides of a user's face. FIG. 5B shows a final result after the device has been used along a desired trim path and demonstrates how the device may be used to achieve a consistent trim on both sides of a user's face. In this use of the embodiment, the desired path is a “C-shaped” outline, beginning with the user's temple and continuing to the user's jawline or mouth. The C-shaped outline was created by manipulating the trimmer body 200 and maintaining the same orientation angle 140, however, other users may pivotally adjust the orientation angle 140 to avoid manipulating the trimmer body 200 to the same extent. A user may be a person using the device or having the device used upon them. Different users may prefer or require different orientation angles to aid in the ease of use or comfortability of the device.

The device may be used to create a partial or full C-shaped outline with a different length, size, or depth, or the like or a combination or sub-combination thereof. The device may also be used for hair in a variety of locations on a user face such as facial hair or sideburns, as well as generally hair on a user's temples, a user's head, a user's neck, and a user's body. For example, the device may be used to trim a style onto the neck of user where one or more C-shapes represent waves. Other examples include the trimming of fin-like shapes on the sides of a user's head or curved slashes on a user's eyebrows. These examples are non-limiting as users of the device may be creative and produce different shapes and styles with the various embodiments and various orientation angles 140.

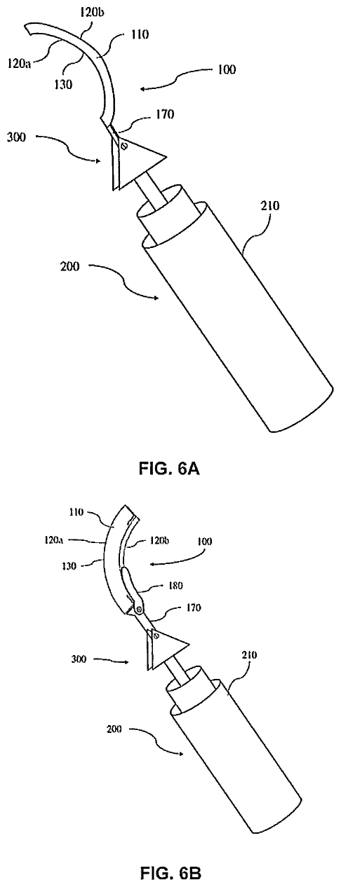

Referring to FIG. 6A and 6B, one non-limiting embodiment of the trimmer head 100 may be comprised of a blade member 110 with an elliptical shape (e.g., a shape similar to a sickle, scythe, C-shape, or the like or a combination or sub-combination thereof). The blade member 110 may have one or more curved edge regions 120. At least one of the curved edge regions 120 may have one or more cutting edges 130 located on the at least one curved edge region 120. Optionally, trimmer head 100 may be further comprised of an arm 170, wherein the arm 170 may be connected to the blade member 110. In certain embodiments, the arm 170 may be releasably connected to the attachment mechanism 300. The arm 170 may include a rear guard 180 attached to the arm 170 and encompassing a portion of the blade member 110. The rear guard 180 may be designed to protect the back side of the blade member 110 or allow a user to apply force to the rear guard 180 in order to aid in the trimming process or provide additional control. The rear guard 180 may be pivotally adjustable and extend away from the blade member 110. In certain embodiments, the rear guard 180 may be configured to detach the trimmer head 100 from the attachment mechanism 300. For example, the rear guard 180 may be pivoted away from the blade member 110 and trigger a release in the attachment mechanism 300, or in a method similar to the one described.

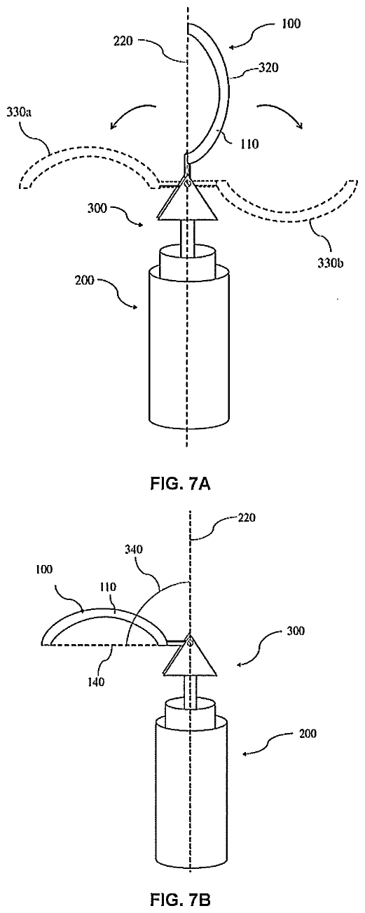

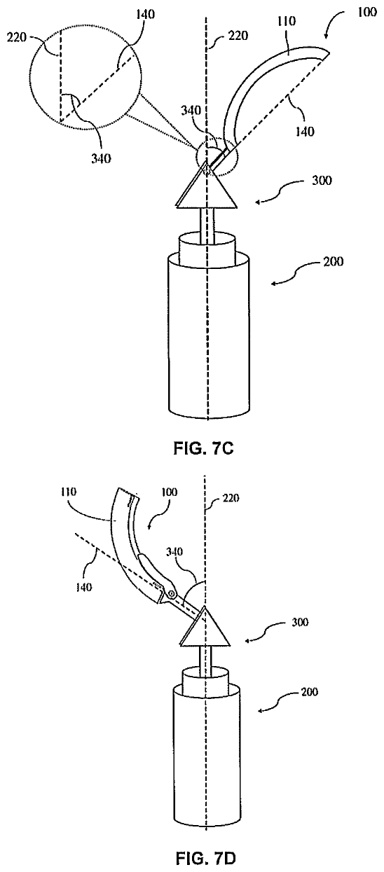

Referring to FIG. 7A-D, in certain embodiments the trimmer head 100 may be pivotal between at least one first fixed use position 320 and at least one second fixed use position 330, wherein both the at least one first fixed use position 320 and the at least one second fixed use position 330 are defined by an orientation angle 340. The orientation angle 340 may be defined by a degree between a center axis 140 and the longitudinal axis 220. The center axis 140 may be defined by the arm 170 or a substantially linear line between the two ends of the blade member 110. In other embodiments, the center axis 140 may be defined by the substantially linear line between the two inner edges or corners of the curved edge region 120.

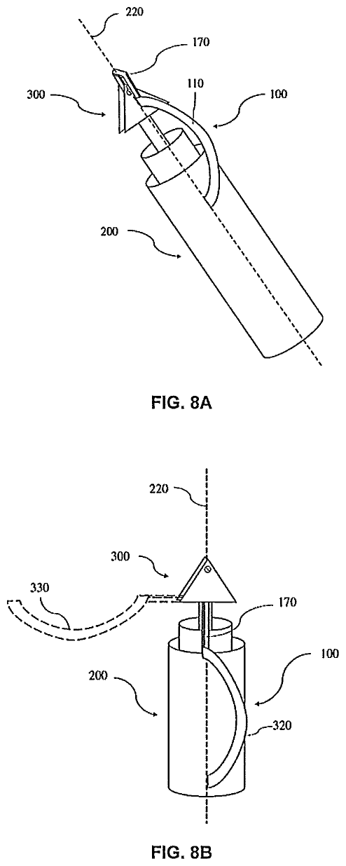

Referring to FIG. 8A, in certain embodiments the trimmer head 100 may be positioned lateral to the longitudinal axis 220 of the trimmer body 200 such that the trimmer head 100 may be positioned on a second longitudinal plane 260. The second longitudinal plane 260 may also include a second longitudinal axis (the second longitudinal axis may be represented by the second longitudinal plane 260 in certain figures and embodiments). The arm 170 may be pivotally connected to either the attachment mechanism or to the blade member 110 such that the blade member 110 can pivot between a first fixed use position 320 and a second fixed use position 330 along the second longitudinal plane 260. The second longitudinal plane 260 may be orthogonal or parallel to the first longitudinal plane. The orientation angle 140 may be defined by the degree between the center axis 140 of the arm 170 in relation to the blade member 110 or by the substantially linear line between the two ends of the blade member 110, and the second longitudinal axis 260. In other embodiments, the orientation angle 140 may be defined by the degree between the center axis 140 and the longitudinal axis 220.

In one non-limiting embodiment, the degree of the orientation angle 340 may be between negative 360 degrees and positive 360 degrees (e.g., the blade member 110 can pivot in a full circle in either direction, or the like or a combination or sub-combination thereof). In other embodiments, the degree of the orientation angle 340 may be only negative 360 degrees or positive 360 degrees. In further embodiments, the orientation angle 340 may be some range between zero and negative 360 degrees or positive 360 degrees.

Referring to FIG. 8B, the trimmer head 100 may be positioned lateral to the trimmer body 200 by releasably connecting to the trimmer head 100 attachment mechanism 300, wherein the attachment mechanism 300 extends laterally away from the longitudinal axis 220 of the trimmer body 200 with suitable intermediate connecting members.

In certain embodiments, when the orientation angle 140 may be negative or positive 180 degrees, the blade member 110 may be considered to be in a storage position. Referring to FIGS. 8A and 8B, some embodiments may include the storage position being laterally adjacent to the trimmer body 200 (e.g., the blade member 110 is generally coplanar with the trimmer body 200). Optionally, the trimmer head 100 or blade member 110 may further include a sheath or cover, or the like, to protect the cutting edge 130 or to protect the users. The cover may be comprised of suitable material such as silicone, plastic, ceramic, or fabric, or the like or a combination or sub-combination thereof.

Other non-limiting embodiments are contemplated within the purview of this disclosure such as the storage position being vertically adjacent to the trimmer body 200 (e.g., the storage position of the blade member 110 or trimmer head 100 may be located on the first longitudinal plane, or the like). In some embodiments, the attachment mechanism 300 includes an open chamber having a first border and a second border opposite to the first border, wherein the storage position of the trimmer head 100 or blade member 110 may be located between the first border and the second border. Optionally, the trimmer head 100, blade member 110, or attachment mechanism 300 may further include a sheath or cover, or the like, to protect the cutting edge 130 or to protect the users. The cover may be comprised of suitable material such as silicone, plastic, ceramic, or fabric, or the like or a combination or sub-combination thereof. In other embodiments, the storage position may be disposed within the trimmer body 200 such that the shaft 210 defines a cavity, wherein the trimmer head 100 or the blade member 110 may be located within the cavity. The cavity protects the trimmer head 100, the blade member 110, and the user.

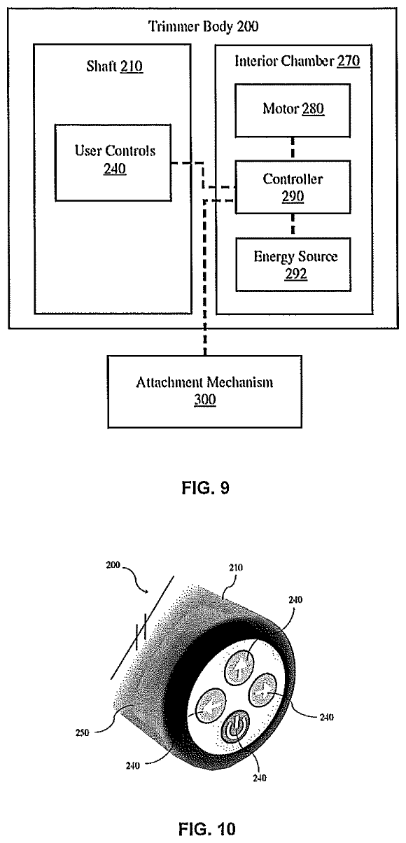

Referring to FIG. 9, in certain embodiments the shaft 210 has an outer body surface 250 that defines at least one interior chamber 270. The interior chamber 270 may include a motor 280 and a controller 290. The motor 280 may be operatively connected to the trimmer head 200. In other embodiments, the motor 280 may be operatively connected to the blade member 110. The motor 280 may be configured to facilitate movement of the trimmer head 100, blade member 110, cutting edge 130, or teeth 150 in a manner sufficient to cut hair or aid in the use of the device. For example, the motor 280 may cause the blade member 110, cutting edge 130, or teeth 150 to move laterally or vertically such that hair located within the general plane of the blade member 110, cutting edge 130, or teeth 150 is cut. Other suitable types of movement or motions of the blade member 110, cutting edge 130, or teeth 150 are contemplated such as circular, pivoting, oscillation, reciprocation, or the like or a combination or sub-combination thereof. The motor 280 may be configured to move the trimmer head 100 or blade member 110 such as by pivoting the trimmer head 100 or blade member 110 to a different orientation angle 340 in order to provide users an easier or more comfortable means to cut or trim hair in a desired location.

The controller 290 may selectively connect the motor to an internal or external energy source 292 that provides electrical power to the device. In certain embodiments, the energy source 292 may be one or more batteries disposed within the interior chamber 270. The battery may be disposable such that the interior chamber 270 may be opened to facilitate the replacement of the battery. In other embodiments, the battery may be rechargeable by any suitable means such as supplying power to the battery via a connector located on the outer body surface of the shaft 250, using solar power via a solar cell located on the outer body surface of the shaft 250, using wireless charging means, or the like or a combination or sub-combination thereof. In further embodiments, the energy source 292 may be an electric source such as a power outlet, or the like. The attachment mechanism 300 may be operatively connected to the connected to the controller 290. For example, the controller 290 controls the attachment mechanism 300 and causes the trimmer head 100 to pivot from a first fixed use position 320 to a second fixed use position 330.

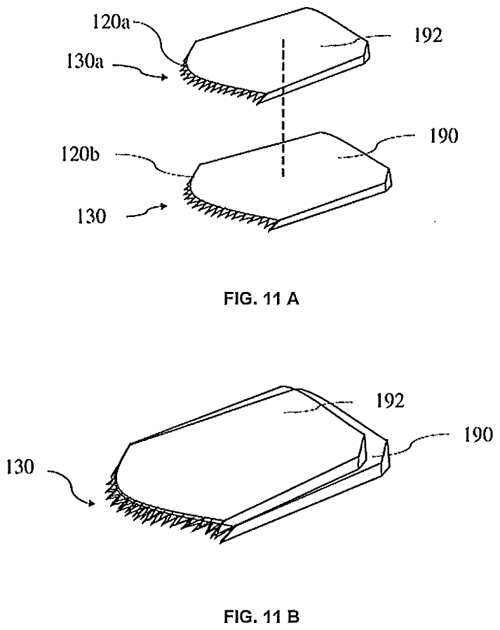

Referring to FIGS. 9 and 10, in certain embodiments the shaft 210 may include one or more user controls 240 disposed on the outer body surface 250 of the shaft 210 (e.g., on the bottom of the shaft, sides of the shaft, or the like, or a combination thereof). In other non-limiting embodiment, the user controls 240 may be disposed in other ergonomic locations or locations where the user controls 240 are protected (e.g., within an interior chamber 270 that is accessible by removing or opening a panel member, or the like). In some embodiments, the user controls 240 may be disposed on a remote device or on a smart phone via an application (e.g., the user controls 240 may send wireless signals that may be received by the controller 290, or the like). The user controls 240 may be operatively connected to the controller 290 such that input to the user controls 240 sends signals to the controller 290. For example, the user controls 240 may include buttons to pivotally adjust the trimmer head 100 in response to being pressed by the user (e.g., a user may press a button to pivot the trimmer head 100 to the left, right, or center depending on the orientation angle 140, or a user may press a button to return the trimmer head 100 to a preset orientation angle, or the like, or a combination or sub-combination thereof). The user controls 240 may also include a power button to disconnect the motor 280 from the energy source 292. Optionally, the user controls 240 may have multiple functions based on the type of input received from the user (e.g., a single press, double press, prolonged press, or the like, or a combination or sub-combination thereof).

Referring to FIG. 11, in certain embodiments, the at least one blade member 110 includes a stationary blade 190 and a reciprocating blade 192 disposed vertically adjacent to the stationary blade (e.g., the reciprocating blade 192 may be above or below the stationary blade 190, or the like). At least either the stationary blade 190 or the reciprocating blade 192 has a curved cutting region 130 located proximate to the curved edge region 120 of the least one blade member 110. In some embodiments, the stationary blade 190 and the reciprocating blade 192 both have a curved cutting region 130 that may be defined by an arc having an arc angle 160 between suitable ranges, similar to those listed previously for at least one curved edge region 120. In certain embodiments, the arc angle 160 may be identical for both the stationary blade and the reciprocating blade. The stationary blade 190 and the reciprocating blade 192 both have teeth 150. The shape, size, and material of the stationary blade 190 and reciprocating blade 192 are similar to that of the blade member 110 contemplated previously.

The reciprocating blade 192 may be configured to move relative to the stationary blade 190. For example, the reciprocating blade 192 may be configured to reciprocate relative to the stationary blade 190, or by other means of movement or motion previously contemplated. In certain embodiments, the teeth of the reciprocating blade 192 reciprocate laterally such that the hair between the teeth 150 of the stationary blade 190 and the reciprocating blade 192 is cut. The movement of the reciprocating blade 192 may be defined relative the stationary blade 190. For example, the outer bounds of the movement of the reciprocating blade 192 may be outside or inside the bounds of the shaped defined by the stationary blade 190. The portion of the reciprocating blade 192 that may remain within the bounds of the stationary blade 190 when the reciprocating blade 192 moves outside of the outside bounds of the stationary blade 190 vary according to certain embodiments.

In certain embodiments, the motor 280 may be configured to control the movement of the reciprocating blade. In other embodiments, the attachment mechanism 300 may be configured to control the movement of the reciprocating blade.

In one-non limiting embodiments the device may include a cutting unit 100, a handle 200, and a pivoting mechanism 300. The cutting unit 100 may have a planar body having at least one curvilinear edge region 120 and one or more cutting edges 130 located at the at least one curvilinear edge region 120. The at least one curvilinear edge region 120 may be coplanar to the planar body of the cutting unit 100. The handle 200 may define a longitudinal axis 220 and a first longitudinal plane and the handle 200 has an outer surface, wherein one or more user controls 240 may be disposed on the outer surface of the handle 200. The pivoting mechanism 300 may be connected to the handle 200 and the cutting unit 100 may be releasably attached to the pivoting mechanism 300. The pivoting mechanism 300 may be configured to pivotally adjust the cutting unit 100 between at least one first fixed use position 320 and at least one second fixed use position 330 on a pivot plane orthogonal to the first longitudinal plane. The at least one first fixed use position 320 and the at least one second fixed use position 330 may be defined by an orientation angle 340. The orientation angle 340 may be defined by a degree between a center axis 140 of the cutting unit 100 and the longitudinal axis 220.

In another embodiment, the device includes a trimmer head 100, a trimmer body 200, and an attachment mechanism 300. The trimmer head 100 may include at least one blade member 110, wherein the at least one blade member 110 has a planar body having at least one curved edge region 120 and one or more cutting edges 130 located at least one curved edge region 120. The at least one curved edge region 120 may be coplanar to the planar body of the at least one blade member 110. The curved edge region 120 may be defined by an arc having an arc angle 160 between 45 degrees and 180 degrees. The trimmer body 100 may include a shaft 210 that defines a longitudinal axis 220 and a first longitudinal plane. The shaft 210 has a first end 212 and second end 214 opposed to the first end 212, and an outer body surface 250 that defines at least one interior chamber 270. The at least one interior chamber 270 may include a motor 280 and a controller 290. The motor 280 may be disposed in the at least one interior chamber 270 defined in the shaft 210, wherein the motor 280 may be operatively connected to the trimmer head 100. The controller 290 selectively connects the motor 280 to an energy source 292, and wherein the controller 290 may be operatively connected to one or more user controls 240. The attachment mechanism 300 may be positioned at the first end 212 of the shaft 210 and the trimmer head 100 may be releasably connected to the attachment mechanism 300. Once connected to the attachment mechanism 300, the trimmer head 100 may be pivotal between at least one first fixed use position 320 and at least one second fixed use position 330 on a pivot plane orthogonal to the first longitudinal plane. Both the at least one first fixed use position 320 and the at least one second fixed use position 330 are defined by an orientation angle 340, wherein the orientation angle 340 may be defined by a degree between a center axis 140 of the at least one blade member 110 and the longitudinal axis 220 and wherein the attachment mechanism 300 may be operatively connected to the controller 290.

In some embodiments, the attachment mechanism 300 may be referred to as a pivoting mechanism. In other embodiments, the trimmer head 100 may be referred to as a cutting unit. In further embodiments, the curved edge region 120 may be referred to as a curvilinear edge region. In certain embodiments, the cutting edge 130 may be referred to as a curved cutting region.

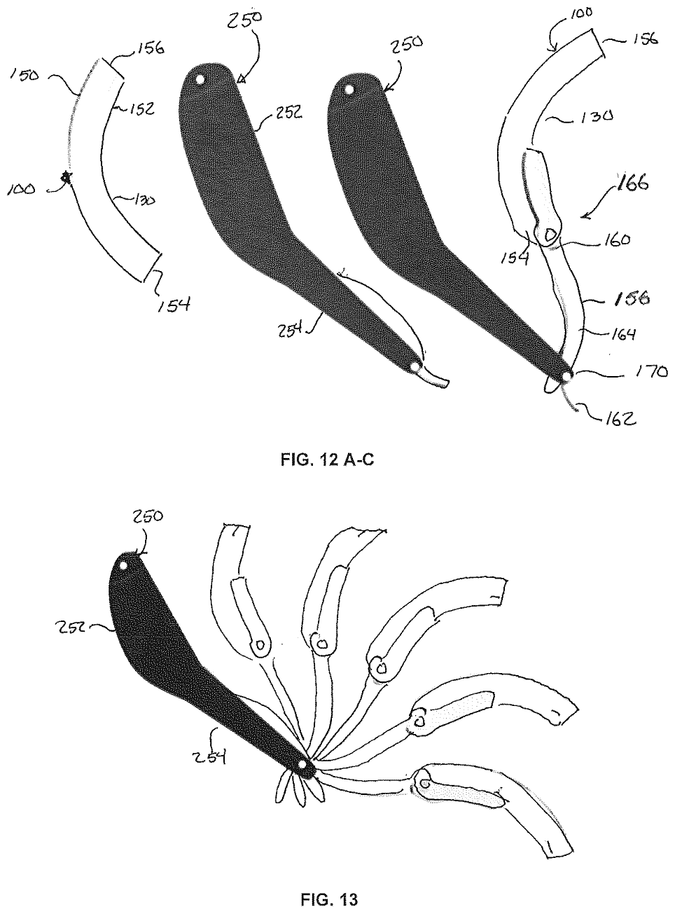

An additional embodiment of the grooming device as disclosed herein is depicted in FIGS. 12A-C and FIG. 13. The grooming device includes curved blade member 100 In the embodiment as illustrated, the curved blade member has a blade body member 100 that includes a convex edge 150 and a concave disposed a spaced distance therefrom. The convex edge 150 and the concave edge 152 can be disposed parallel to one another along at least a portion of the blade body 110. In the embodiment as illustrated in FIG. 12A, the convex edge 150 and the concave edge 152 are disposed parallel to one another along the entire blade body 110 forming a general C shape member. The curved blade member 100 includes at least one cutting edge 130 defined on at least a portion of one of concave edge 152 and/or convex edge 150. In the embodiment as illustrated in FIG. 12A-C, the at least one cutting edge 130 can be located on at least a portion of the concave surface 152. The curved blade member 100 also includes a first end 154 and a second end 156 opposed to the first end 154. IN certain embodiments, the at least one cutting edge 130 can extend continuously or intermittently from the first end 156 to the second end 156 or some segment thereof.

The embodiment as illustrated in FIGS. 12A-C may also include at least one sheath member 250 configured to removably receive the curved blade member therein 100. N certain embodiments, the sheath member 250 can also function as trimmer body 200 to facilitate holding and manipulation of the device 10 when the curved blade member 100 is in the extended or use position. Where desired or required, the sheath member 250 can be configured with a curved blade member holding portion 252 and an arm projection 254 extending therefrom.

The embodiment of the device 10 as depicted in FIGS. 12A-C also includes a blade extension arm member 158 connected to the first end 154 of the blade body member 100 and extending outward therefrom. In the embodiment as illustrated in FIGS. 12A-C, the blade extension arm member 158 has a first end 160 and an opposed second end 162 with a body 164 located therebetween. The body 164 can have any suitable configuration. In the embodiment illustrated in FIGS. 12A-C, the body 164 is curved.

The assembly formed by the curved blade member 130 and the blade extension arm member 158 cooperatively form an assembly 166 that is pivotally connected to the sheath 250 at connection member 170.

Where desired or required, connection member 170 can be configured to provide pivotal movement between at least two indexed positions relative to the sheath member 250. The at least two indexed positions can be orientation of sheath member 250 to curved blade member 100 to facilitate styling operations.

The connection member 170 can be configured to facilitate a plurality of indexing options. In the embodiment as depicted in FIG. 13, five indexing options are illustrated. Greater or lesser numbers are contemplated in this disclosure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A device comprising:
a trimmer head, the trimmer head including at least one blade member, wherein the at least one blade member has a planar body having at least one curved edge region and one or more cutting edges located on the at least one curved edge region, the at least one curved edge region being coplanar to the planar body of the at least one blade member;
a trimmer body, the trimmer body including:
a shaft defining a longitudinal axis and a longitudinal plane, the shaft including a first end and second end opposed to the first end; and
an attachment mechanism positioned at the first end of the shaft, wherein the trimmer head is releasably connected to the attachment mechanism, wherein the trimmer head is pivotal between at least one first fixed use position and at least one second fixed use position on pivot plane orthogonal to the longitudinal plane, wherein both the at least one first fixed use position and the at least one second fixed use position are defined by an orientation angle, wherein the orientation angle is defined by a degree between a center axis of the trimmer head and the longitudinal axis.

2. The device of claim 1 wherein the shaft has an outer body surface defining at least one interior chamber, the at least one interior chamber including a motor disposed in the at least one interior chamber defined by the shaft, wherein the motor is operatively coupled to the attachment mechanism and operatively connected to the trimmer head,
a controller, the controller selectively connecting the motor to an energy source, and;
one or more user controls disposed on the trimmer body, wherein the one or more user controls are operatively connected to the controller and motor.

3. The device of claim 2 wherein the at least one blade member includes a stationary blade and a reciprocating blade disposed vertically adjacent to the stationary blade, wherein the reciprocating blade reciprocates relative to the stationary blade, and wherein at least the stationary blade has a curved cutting region located proximate to the curved edge region of the least one blade member.

4. The device of claim 3 wherein the stationary blade and the reciprocating blade both have a curved cutting region defined by an arc, the arc having an arc angle between 45 degrees and 180 degrees.

5. The device of claim 4 wherein the arc angle of the curved cutting region is identical for both the stationary blade and reciprocating blade.

6. The device of claim 5 wherein the motor facilitates reciprocating movement of the reciprocating blade.

7. The device of claim 6 wherein the one or more cutting edges of both the stationary blade and the reciprocating blade includes two or more teeth.

8. The device of claim 2 wherein the shaft has an outer surface, and the one or more user controls are disposed on the outer surface of the shaft.

9. The device of claim 1 wherein the orientation angle is between negative 90 degrees and positive 90 degrees relative to the longitudinal axis.

10. The device of claim 1 wherein the at least one curved region of the at least one blade is defined by an arc, the arc having an arc angle between 45 degrees and 180 degrees.

11. A device comprising:
a cutting unit, wherein the cutting unit has a planar body having at least one curvilinear edge region and one or more cutting edges located at the at least one curvilinear edge region, the at least one curvilinear edge region being coplanar to the planar body of the cutting unit;
a handle defining a longitudinal axis and a first longitudinal plane, the handle having an outer surface, wherein one or more user controls are disposed on the outer surface of the handle;
a pivoting mechanism connected to the handle, wherein the cutting unit is releasably attached to the pivoting mechanism, and wherein the pivoting mechanism pivotally adjusts the cutting unit between at least one first fixed use position and at least one second fixed use position on a pivot plane orthogonal to the first longitudinal plane, wherein the at least one first fixed use position and the at least one second fixed use position are defined by an orientation angle, wherein the orientation angle is defined by a degree between a center axis and the longitudinal axis.

12. The device of claim 11, wherein the handle has an outer body surface defining at least one interior chamber, the at least one interior chamber including:
a motor disposed in the at least one interior chamber defined in the handle, wherein the motor is operatively connected to the pivoting mechanism, and wherein the motor is operatively connected to the cutting unit; and
a controller, the controller selectively connecting the motor to an energy source, and wherein the controller is operatively connected to the one or more user controls.

13. The device of claim 12 wherein the cutting unit includes a stationary blade and a reciprocating blade disposed vertically adjacent to the stationary blade, wherein the reciprocating blade reciprocates relative to the stationary blade, and wherein at least the stationary blade has a curved cutting region located proximate to the curvilinear edge region of the cutting unit, the curved cutting region being defined by an arc, the arc having an arc angle between 45 degrees and 180 degrees.

14. The device of claim 12 wherein either the at least one first fixed use position or the at least one second fixed use position is a storage position, the storage position having an orientation angle of positive or negative 180 degrees.

15. The device of claim 14 wherein the pivoting mechanism includes an open chamber, the open chamber having a first border and a second border opposite to the first border, wherein the storage position of the cutting unit is located between the first border and the second border, and wherein the storage position of the cutting unit is located on the first longitudinal plane.

16. The device of claim 14 wherein the cutting unit is located on a second longitudinal plane, and wherein the second longitudinal plane is situated lateral to the longitudinal axis.

17. The device of claim 14 wherein the storage position of the cutting unit is laterally adjacent to the handle.

18. A device comprising:
a trimmer head, the trimmer head including at least one blade member, wherein the at least one blade member has a planar body having at least one curved edge region and one or more cutting edges located at least one curved edge region, the at least one curved edge region being coplanar to the planar body of the at least one blade member, and wherein the curved edge region is defined by an arc, the arc having an arc angle between 45 degrees and 180 degrees;
a trimmer body, the trimmer body including:
a shaft defining a longitudinal axis and a first longitudinal plane, the shaft including a first end and second end opposed to the first end, and wherein the shaft has an outer body surface defining at least one interior chamber, the at least one interior chamber including,
a motor disposed in the at least one interior chamber defined in the shaft, and wherein the motor is operatively connected to the trimmer head, and
a controller, the controller selectively connecting the motor to an energy source, and wherein the controller is operatively connected to one or more user controls; and
an attachment mechanism positioned at the first end of the shaft, wherein the trimmer head is releasably connected to the attachment mechanism, wherein the trimmer head is pivotal between at least one first fixed use position and at least one second fixed use position on a pivot plane, wherein both the at least one first fixed use position and the at least one second fixed use position are defined by an orientation angle, wherein the orientation angle is defined by a degree between a center axis and the longitudinal axis and wherein the attachment mechanism is operatively connected to the controller.

19. The device of claim 18 wherein the orientation angle is between negative 180 degrees and positive 180 degrees relative to the longitudinal axis.

20. The device of claim 18 wherein the trimmer head is positioned on a second longitudinal plane, and wherein the second longitudinal plane is situated lateral to the longitudinal axis defined by the shaft.
